(19) United States
(12) Patent Application Publication
(10) Pub. No.: US 2025/0373149 A1
(43) Pub. Date: Dec. 4, 2025

(54) CONTROL METHODS FOR DIRECT CURRENT CONVERSION CIRCUITS

(71) Applicant: Santak Electronic (Shenzhen) Co., Ltd., Shenzhen (CN)

(72) Inventors: Zilong Yang, Shenzhen (CN); Dongyu Zhang, Shenzhen (CN); Shuqin Zhuang, Shenzhen (CN)

(21) Appl. No.: 19/219,101

(22) Filed: May 27, 2025

(30) Foreign Application Priority Data
May 31, 2024 (CN) 202410698778.8

(51) Int. Cl. H02M 1/32; H02M 1/00; H02M 3/158

(52) U.S. Cl. CPC H02M 1/32; H02M 1/0009; H02M 3/1582

(57) ABSTRACT

A control method for a direct current conversion circuit is provided. The direct current conversion circuit is connected between an energy storage apparatus and direct current buses, and includes at least one buck/boost circuit module and at least one full-bridge circuit module that are connected in parallel. The control method includes an external voltage control loop and an internal current control loop. Each of the at least one buck/boost circuit module and the at least one full-bridge circuit module corresponds to one internal current control loop. The control method includes: obtaining a voltage error based on a predetermined bus reference voltage and an actual bus voltage; obtaining a current reference value for the internal current control loop based on the voltage error; and disconnecting the at least one full-bridge circuit module when the current reference value is less than a threshold.

### CLAIM OF PRIORITY

The present application claims the benefit of and priority to Chinese Inventive concept Patent Application No. 202410698778.8, titled “CONTROL METHOD FOR DIRECT CURRENT CONVERSION CIRCUIT” filed on May 31, 2024, the content of which is hereby incorporated herein by reference in its entirety.

### FIELD

The present inventive concept relates generally to the field of power electronics, and in particular, to control methods for direct current conversion circuits.

### BACKGROUND

In an uninterruptible power supply (UPS), when a mains supply is out of range or cannot be used, the uninterruptible power supply uses a battery to supply power to a load. When the battery supplies power to the load, a boost circuit needs to be used to boost a voltage from the battery and then transmit the voltage to the load. The boost circuit may include a plurality of boost modules connected in parallel to share power, so that a single boost module shares less power. In such a boost circuit, current distribution between the plurality of boost modules needs to be considered. Therefore, a control policy needs to be used to control each boost module.

### SUMMARY

In view of the foregoing, the present inventive concept provides a control method for a direct current conversion circuit. The direct current conversion circuit is connected between an energy storage apparatus and direct current buses, and includes at least one buck/boost circuit module and at least one full-bridge circuit module that are connected in parallel. The control method includes an external voltage control loop and an internal current control loop. Each of the at least one buck/boost circuit module and the at least one full-bridge circuit module corresponds to one internal current control loop. The control method includes:
obtaining a voltage error based on a predetermined bus reference voltage and an actual bus voltage;
obtaining a current reference value for the internal current control loop based on the voltage error; and
disconnecting the at least one full-bridge circuit module when the current reference value is less than a threshold.

In some embodiments, the control method further includes:
continuously monitoring the current reference value, and when the current reference value is greater than the threshold, reconfiguring the at least one full-bridge circuit module to an operating mode.

In further embodiments, the control method further includes:
when reconfiguring the at least one full-bridge circuit module to be in a boost mode, configuring a predetermined startup duty cycle for the at least one full-bridge circuit module, so that an output voltage of the at least one full-bridge circuit module is greater than or equal to the bus voltage and is less than a predetermined bus voltage maximum value in a first pulse width modulation period.

In still further embodiments. the predetermined startup duty cycle is:

$$\frac{1}{2} - \frac{{V}_{BAT}}{2 {V}_{busmax}} > D \geq \frac{1}{2} - \frac{{V}_{BAT}}{2 {V}_{bus}}$$

wherein D is the predetermined startup duty cycle, VBAT is an energy storage apparatus voltage, Vbus is the bus voltage, and Vbusmax is the predetermined bus voltage maximum value.

In some embodiments, the internal current control loop includes:
for each buck/boost circuit module, obtaining a first current error based on a current reference value of a corresponding proportion and an output current of the buck/boost circuit module; and
obtaining, through proportional-integral-derivative control based on the first current error, a first duty cycle used to control the buck/boost circuit module.

In further embodiments, the internal current control loop includes:
for each full-bridge circuit module, obtaining a second current error based on a current reference value of a corresponding proportion and an output current of the full-bridge circuit module; and
obtaining, through proportional-integral-derivative control based on the second current error, a second duty cycle used to control the full-bridge circuit module.

In still further embodiments, the control method further includes:
obtaining the output current of the buck/boost circuit module based on the first duty cycle; and obtaining the output current of the full-bridge circuit module based on the second duty cycle.

In some embodiments, the control method further includes:
obtaining a bus current based on the output current of the at least one buck/boost circuit module and the output current of the at least one full-bridge circuit module; and
obtaining an actual bus voltage based on the bus current.

In further embodiments, the current reference value is obtained through proportional-integral-derivative control based on the voltage error.

In still further embodiment, the direct current conversion circuit operates in a boost mode in which the energy storage apparatus supplies power to the direct current buses.

According to a control method for a direct current conversion circuit in the present inventive concept, a current of a full-bridge circuit is prevented from changing to a negative value when a current reference value is less than a threshold, thereby protecting an energy storage apparatus and avoiding frequent charging and discharging of the energy storage apparatus.

### BRIEF DESCRIPTION OF THE DRAWINGS

FIG. 1 is a schematic diagram illustrating a direct current conversion circuit according to an embodiment.

FIG. 2 is a schematic diagram illustrating a control logic of the direct current conversion circuit shown in FIG. 1.

FIG. 3 is a schematic diagram illustrating a current of an inductor of a full-bridge circuit module and a pulse width modulation (PWM) signal in a case of a small load.

FIG. 4 is a flowchart illustrating a control method for a direct current conversion circuit according to some embodiments of the present inventive concept.

FIG. 5 is a current waveform illustrating when a control method for a direct current conversion circuit according to some embodiments of the present inventive concept is used in a case of a small load.

FIG. 6 is a current waveform illustrating when a control method for a direct current conversion circuit according to some embodiments of the present inventive concept is not used in a case of a small load.

FIG. 7 is a current waveform in a case of a high load.

### DETAILED DESCRIPTION

To make the objectives, technical solutions, and advantages of the present inventive concept clearer, the following further describes the present inventive concept in detail through the embodiments with reference to the accompanying drawings. It should be noted that the embodiments provided in the present inventive concept are used only for description, and are not intended to limit the protection scope of the present inventive concept.

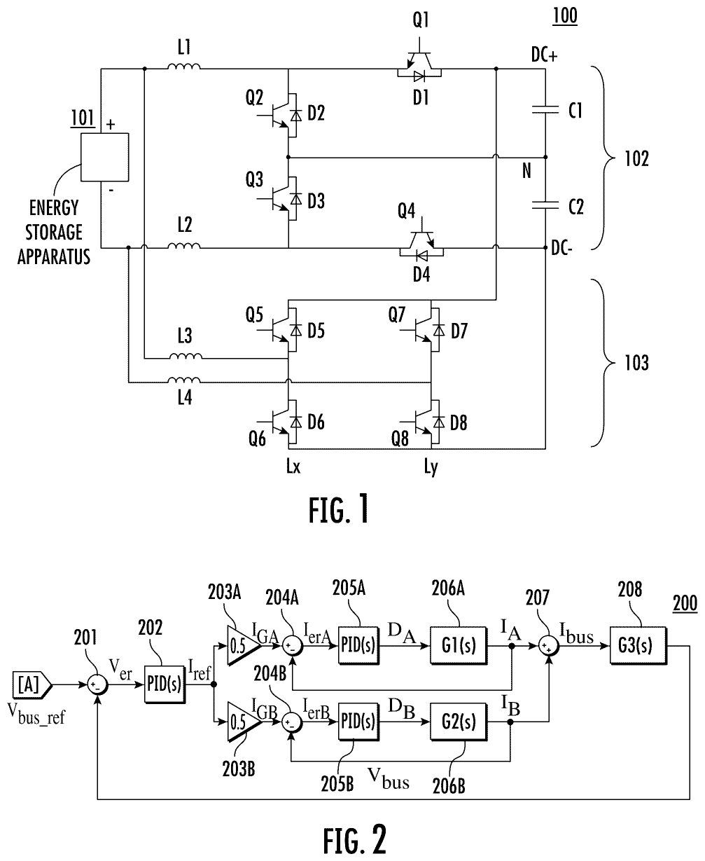

FIG. 1 shows a schematic diagram of a direct current conversion circuit according to an embodiment. The direct current conversion circuit 100 is connected between an energy storage apparatus 101 and direct current buses. A positive direct current bus capacitor C1 and a negative direct current bus capacitor C2 are connected in series between a positive direct current bus DC+ and a negative direct current bus DC−. A node between the positive direct current bus capacitor C1 and the negative direct current bus capacitor C2 is connected to a neutral line N, and the neutral line N may be grounded or not grounded. In an embodiment, the energy storage apparatus 101 is a rechargeable battery. As shown in FIG. 1, the direct current conversion circuit 100 includes a buck/boost circuit module 102 and a full-bridge circuit module 103.

The buck/boost circuit module 102 includes: a transistor Q1, a transistor Q2, a transistor Q3, and a transistor Q4 that are connected in series between the positive direct current bus DC+ and the negative direct current bus DC−, wherein the transistor Q1, the transistor Q2, the transistor Q3, and the transistor Q4 each have a diode D1, a diode D2, a diode D3, and a diode D4 respectively that are in anti-parallel connection with the transistors, and a node between the transistor Q2 and the transistor Q3 is connected to the neutral line N; an inductor L1, of which a first terminal is connected to a positive electrode+of the energy storage apparatus 101 and a second terminal is connected to a node between the transistor Q1 and the transistor Q2; and an inductor L2, of which a first terminal is connected to a negative electrode−of the energy storage apparatus 101 and a second terminal is connected to a node between the transistor Q3 and the transistor Q4.

Specifically, the transistor Q1 has a first terminal connected to the positive direct current bus DC+, a second terminal connected to the transistor Q2, and a control terminal configured to receive a control signal. A positive electrode of the diode D1 is connected to the second terminal of the transistor Q1, and a negative electrode of the diode D1 is connected to the first terminal of the transistor Q1. The transistor Q2 has a first terminal connected to the transistor Q1, a second terminal connected to the transistor Q3, and a control terminal configured to receive a control signal. A positive electrode of the diode D2 is connected to the second terminal of the transistor Q2, and a negative electrode of the diode D2 is connected to the first terminal of the transistor Q2. The transistor Q3 has a first terminal connected to the transistor Q2, a second terminal connected to the transistor Q4, and a control terminal configured to receive a control signal. A positive electrode of the diode D3 is connected to the second terminal of the transistor Q3, and a negative electrode of the diode D3 is connected to the first terminal of the transistor Q3. The transistor Q4 has a first terminal connected to the transistor Q3, a second terminal connected to the negative direct current bus DC−, and a control terminal configured to receive a control signal. A positive electrode of the diode D4 is connected to the second terminal of the transistor Q4, and a negative electrode of the diode D4 is connected to the first terminal of the transistor Q4.

In a boost mode in which the energy storage apparatus 101 supplies power to the direct current buses, the control terminals of the transistors Q2 and Q3 receive a same pulse width modulation (PWM) signal, the transistors Q2 and Q3 are periodically turned on or off, and the transistors Q1 and Q4 are always turned off. When the transistors Q2 and Q3 are turned on, a current path is: a positive electrode of the energy storage apparatus—the inductor L1—the transistor Q2—the transistor Q3—the inductor L2—a negative electrode of the energy storage apparatus. In this case, the energy storage apparatus 101 discharges electric energy into the inductors L1 and L2, and the electric energy is stored in the inductors L1 and L2. When the transistors Q2 and Q3 are turned off, a current path is: the inductor L1—the diode D1—the positive direct current bus DC+—the negative direct current bus DC−—the diode D4—the inductor L2. In this case, the inductors L1 and L2 discharge the stored energy to the direct current buses.

The full-bridge circuit module 103 includes an inductor L3, an inductor L4, and a first bridge arm Lx and a second bridge arm Ly that are connected to the inductor L3 and the inductor L4, respectively, wherein the first bridge arm Lx includes a transistor Q5 and a transistor Q6 that are connected in series between the direct current buses, and a diode D5 and a diode D6 that are in anti-parallel connection with the transistor Q5 and the transistor Q6, respectively, a node between the transistor Q5 and the transistor Q6 is connected to a first terminal of the inductor L3, and a second terminal of the inductor L3 is connected to the positive electrode+of the energy storage apparatus; the second bridge arm Ly includes a transistor Q7 and a transistor Q8 that are connected in series between the direct current buses, and a diode D7 and a diode D8 that are in anti-parallel connection with the transistor Q7 and the transistor Q8, respectively, a node between the transistor Q7 and the transistor Q8 is connected to a first terminal of the inductor L4, and a second terminal of the inductor LA is connected to the negative electrode−of the energy storage apparatus 101.

Specifically, the transistor Q5 has a first terminal connected to the positive direct current bus DC+, a second terminal connected to the transistor Q6, and a control terminal configured to receive a control signal. A positive electrode of the diode D5 is connected to the second terminal of the transistor Q5, and a negative electrode of the diode D5 is connected to the first terminal of the transistor Q5. The transistor Q6 has a first terminal connected to the transistor Q5, a second terminal connected to the negative direct current bus DC−, and a control terminal configured to receive a control signal. A positive electrode of the diode D6 is connected to the second terminal of the transistor Q6, and a negative electrode of the diode D6 is connected to the first terminal of the transistor Q6. The transistor Q7 has a first terminal connected to the positive direct current bus DC+, a second terminal connected to the transistor Q8, and a control terminal configured to receive a control signal. A positive electrode of the diode D7 is connected to the second terminal of the transistor Q7, and a negative electrode of the diode D7 is connected to the first terminal of the transistor Q7. The transistor Q8 has a first terminal connected to the transistor Q7, a second terminal connected to the negative direct current bus DC−, and a control terminal configured to receive a control signal. A positive electrode of the diode D8 is connected to the second terminal of the transistor Q8, and a negative electrode of the diode D8 is connected to the first terminal of the transistor Q8.

In the boost mode in which the energy storage apparatus 101 supplies power to the direct current buses, a pulse width modulation (PWM) signal is provided to gates of the transistors Q5 to Q8 to implement on and off of the transistors, so as to implement DC-DC conversion, so that the energy storage apparatus 101 supplies power to the direct current buses.

Specifically, first, the transistor Q6 and the transistor Q7 are controlled to be turned on, the transistor Q5 and the transistor Q8 are controlled to be turned off, and a current path is: the positive electrode of the energy storage apparatus-the inductor L3-the transistor Q6-the negative direct current bus DC−-the positive direct current bus DC+-the transistor Q7-the inductor L4-the negative electrode of the energy storage apparatus. In this case, the inductor L3 and the inductor L4 store energy.

Then, the transistor Q5 and the transistor Q8 are controlled to be turned on, the transistor Q6 and the transistor Q7 are controlled to be turned off, and a current path is: the positive electrode of the energy storage apparatus-the inductor L3-the transistor Q5-the positive direct current bus DC+-the negative direct current bus DC−-the transistor Q8-the inductor L4-the negative electrode of the energy storage apparatus. In this case, the inductor L3 and L4 freewheel. In this way, the charging of the direct current bus capacitors C1 and C2 is implemented, and boosting is implemented.

In the foregoing embodiment, the PWM control signals sent to the control terminal of the transistor Q1 to Q8 may be provided by a dedicated controller. For example, the controller is configured to include a processing circuit for performing on/off drive control of each transistor. The processing circuit may include digital electronic circuits such as an operation processing apparatus and a memory apparatus, may include analog electronic circuits such as a comparator, an operational amplifier, and a differential amplifier, or may include both digital electronic circuits and analog electronic circuits.

Those skilled in the art should understand that the transistor may implement bidirectional current conduction, that is, a current from the first terminal to the second terminal or a current from the second terminal to the first terminal. In addition, the diodes connected in anti-parallel with the transistors may be integrated within the transistors, and are configured to implement freewheeling in a switching gap of the transistors.

Although the transistors Q1 to Q8 in FIG. 1 are shown as NPN structures, the present inventive concept is not limited thereto, and the transistors Q1 to Q8 may also be implemented as PNP structures. In an embodiment, the transistors Q1 to Q8 include but are not limited to insulated gate bipolar transistors (IGBT) or metal-oxide semiconductor field-effect transistors (MOSFET).

Although FIG. 1 shows specific circuits of the buck/boost circuit module and the full-bridge circuit module, the present inventive concept is not limited thereto. In actual application, any buck/boost circuit and any controllable full-bridge circuit may be used.

Although FIG. 1 shows only one buck/boost circuit module and one full-bridge circuit module, the present inventive concept is not limited thereto. Based on a power sharing requirement, the direct current conversion circuit in FIG. 1 may include a plurality of buck/boost circuit modules and a plurality of full-bridge circuit modules. In an embodiment, the direct current conversion circuit of the present inventive concept includes at least one buck/boost circuit module and at least one full-bridge circuit module.

In an embodiment, the direct current conversion circuit in FIG. 1 may also operate in a buck mode in which the direct current buses charge the energy storage apparatus.

FIG. 2 shows a schematic diagram of a control logic of the direct current conversion circuit shown in FIG. 1. The direct current conversion circuit is connected between an energy storage apparatus and a direct current bus, and includes one buck/boost circuit module and one full-bridge circuit module that are connected in parallel. A person skilled in the art should understand that the control logic in FIG. 2 may also be applied to a direct current conversion circuit that includes a plurality of buck/boost circuit modules and a plurality of full-bridge circuit modules.

FIG. 2 is a dual-loop control logic that includes an external voltage control loop and an internal current control loop. The control logic includes the external voltage control loop, an internal buck/boost circuit module current control loop, and an internal full-bridge circuit module current control loop.

The external voltage control loop includes an adder 201 and an external voltage controller 202. The adder 201 is configured to receive a predetermined bus reference voltage Vbus_ref and a bus voltage Vbus between positive/negative direct current buses that is output by the direct current conversion circuit, and a voltage error Ver is obtained by performing subtraction between the predetermined bus reference voltage Vbus_ref and the bus voltage Vbus. The external voltage controller 202 is configured to receive the voltage error Ver, and convert the voltage error Ver into a current reference value Iref. The current reference value Iref is related to a load. Generally, a larger load indicates a larger current reference value Iref, and a smaller load indicates a smaller current reference value Iref. In an embodiment, the external voltage controller 202 is a proportional integral differential (PID) controller that obtains the current reference value Iref by means of proportional integral differential control based on the voltage error Ver.

In an embodiment, the predetermined bus reference voltage Vbus_ref is a value set by a user according to experience. In an embodiment, the predetermined bus reference voltage Vbus_ref is a value set by the user according to an experiment.

The internal buck/boost circuit module current control loop includes an amplifier 203A, an adder 204A, and a buck/boost current controller 205A. The amplifier 203A is configured to receive the current reference value Iref and multiply the current reference value Iref by a corresponding proportion to obtain a gain current IGA. In an embodiment, the corresponding proportion is a value between 0 and 1 set by the user. In an embodiment, the corresponding proportion is 1/n (n is a total quantity of the buck/boost circuit module and the full-bridge circuit module, and n=2 in this embodiment). The adder 204A is configured to receive the gain current IGA and an output current IA of the buck/boost circuit module, and a current error IerA is obtained by performing subtraction between the gain current IGA and the output current IA. The buck/boost current controller 205A is configured to receive the current error IerA, and convert the current error IerA into a duty cycle DA. In an embodiment, the buck/boost current controller 205A is a proportional integral differential (PID) controller that obtains the duty cycle DA by means of proportional integral differential control based on the current error IerA.

A buck/boost circuit module physical model 206A (i.e., G1(s)) is configured to receive the duty cycle DA and output the current IA.

The internal full-bridge circuit module current control loop includes an amplifier 203B, an adder 204B, and a full-bridge current controller 205B. The amplifier 203B is configured to receive the current reference value Iref and multiply the current reference value Iref by a corresponding proportion to obtain a gain current IGB. In an embodiment, the corresponding proportion is a value between 0 and 1 set by the user. In an embodiment, the corresponding proportion is 1/n (n is a total quantity of the buck/boost circuit module and the full-bridge circuit module, and n=2 in this embodiment). The adder 204B is configured to receive the gain current IGB and an output current IB of the full-bridge circuit module, and a current error IerB is obtained by performing subtraction between the gain current IGB and the output current IB. The full-bridge current controller 205B is configured to receive the current error IerB, and convert the current error IerB into a duty cycle DB. In an embodiment, the full-bridge current controller 205B is a proportional integral differential (PID) controller that obtains the duty cycle DB by means of proportional integral differential control based on the current error IerB.

A full-bridge circuit module physical model 206B (i.e. G2(s)) is configured to receive the duty cycle DB and output the current IB.

An adder 207 is configured to receive the output current IA of the buck/boost circuit module and the output current IB of the full-bridge circuit module, and add the output current IA and the output current IB together to output a direct current bus current Ibus. A direct current conversion circuit physical model 208 (i.e., G3(s)) is configured to receive the bus current Ibus and output the bus voltage Vbus. The direct current conversion circuit physical model 208 may also be understood as a bus capacitor.

However, the inventors found that some problems may arise when using such a dual-loop control logic. When the bus voltage reaches the predetermined bus reference voltage, and a load of an uninterruptible power supply is small load or no load, an outer loop voltage error Ver is very small, and a current reference value Iref obtained based on the voltage error Ver is very small. A relatively small current reference value Iref may cause an inductor current of the full-bridge circuit module to close to zero, and the current decreases from positive to negative in one PWM period. Therefore, with a PWM frequency, the energy storage apparatus (for example, a battery) frequently changes between a discharging state and a charging state, resulting in an increase in the temperature of the energy storage apparatus, which affects the service life of the energy storage apparatus.

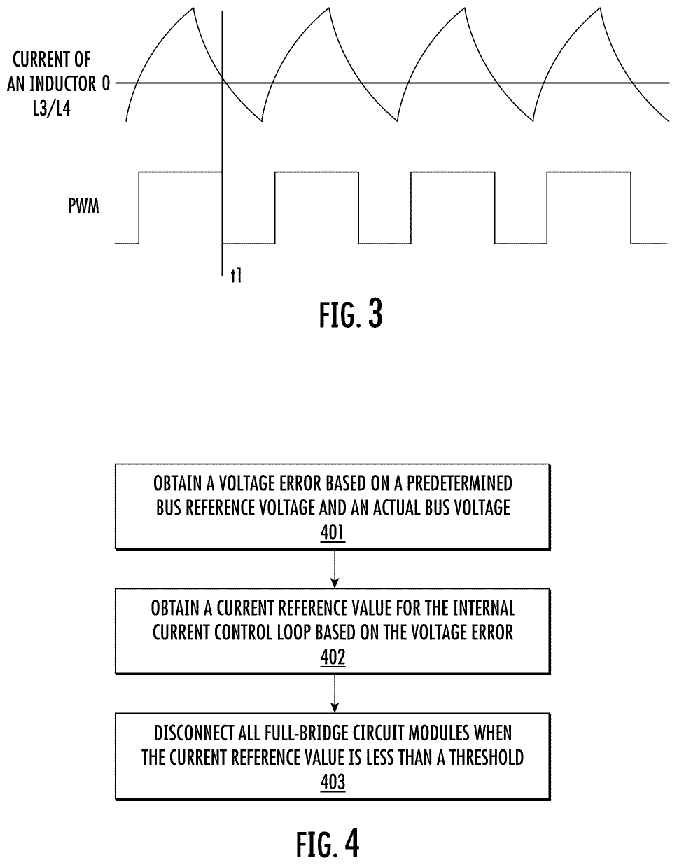

FIG. 3 shows a schematic diagram of a current of an inductor of a full-bridge circuit module and a PWM signal in a case of a small load. The inventors find that, as shown in FIG. 3, when the current of the inductor of the full-bridge circuit module is very small, for example, at a moment t1, when the PWM signal disconnects the transistor, the current continues to decrease, and therefore decreases to a negative value. When a full-bridge circuit is used as a boost converter, there is no diode to prevent a current from flowing from a direct current bus to an energy storage apparatus. Frequently switching between a charging state and a discharging state causes an increase in the temperature of the energy storage apparatus, which is harmful to the energy storage apparatus.

The present inventive concept provides a control method for a direct current conversion circuit, wherein the direct current conversion circuit is connected between an energy storage apparatus and direct current buses, and includes at least one buck/boost circuit module and at least one full-bridge circuit module that are connected in parallel; and the control method includes an external voltage control loop and an internal current control loop, where each of the at least one buck/boost circuit module and the at least one full-bridge circuit module corresponds to one internal current control loop. FIG. 4 shows a flowchart of a control method for a direct current conversion circuit according to some embodiments of the present inventive concept. The control method includes:
step 401: obtaining a voltage error based on a predetermined bus reference voltage and an actual bus voltage;
step 402: obtaining a current reference value for the internal current control loop based on the voltage error; and
step 403: disconnecting all full-bridge circuit modules when the current reference value is less than a threshold.

The disconnecting all full-bridge circuit modules refers to disconnecting all transistors in the full-bridge circuit modules, and the full-bridge circuit modules do not operate and only perform direct current conversion through the buck/boost circuit module. The current only flows through the buck/boost circuit module, and the buck/boost circuit module enters a discontinuous current mode (DCM). The current flows only from the energy storage apparatus to the direct current bus, and no current flows from the direct current bus to the energy storage apparatus.

The current reference value is continuously monitored. When the current reference value is greater than the threshold, the full-bridge circuit module is reconfigured to an operating mode. The operating mode is defined as that a transistor of the full-bridge circuit module is reconfigured to a PWM state.

In a case in which the full-bridge circuit module is reconfigured to a boost mode, if a PWM duty cycle usually rises from 0, under the control of a Gi(s) controller (i.e., G1(s) and G2(s)), when the full-bridge circuit module starts to operate, there will be a large current flowing from the direct current bus to the energy storage apparatus. To avoid this startup problem, a predetermined startup duty cycle needs to be provided for the full-bridge circuit module (i.e., a G2(s) controller), so that a boosting voltage of the full-bridge circuit module in a first PWM period is greater than or equal to a bus voltage and is less than a predetermined bus voltage maximum value, a case in which a current flows from a direct current bus to the energy storage apparatus when the duty cycle starts from 0 is avoided, and an overvoltage of the bus is avoided.

In an embodiment, a range of the predetermined startup duty cycle is:

$$\frac{1}{2} - \frac{{V}_{BAT}}{2 {V}_{busmax}} > D \geq \frac{1}{2} - \frac{{V}_{BAT}}{2 {V}_{bus}} \qquad ( 1 )$$

wherein D is the predetermined startup duty cycle, VBAT is an energy storage apparatus voltage, Vbus is the bus voltage, and Vbusmax is the predetermined bus voltage maximum value.

In an embodiment, the internal current control loop includes: for each buck/boost circuit module, obtaining a first current error based on a current reference value of a corresponding proportion and an output current of the buck/boost circuit module; and obtaining, through proportional-integral-derivative control based on the first current error, a first duty cycle used to control the buck/boost circuit module. The corresponding proportion is a value between 0 and 1 that is set by a user based on an application requirement.

In an embodiment, the internal current control loop includes: for each full-bridge circuit module, obtaining a second current error based on a current reference value of a corresponding proportion and an output current of the full-bridge circuit module; and obtaining, through proportional-integral-derivative control based on the second current error, a second duty cycle used to control the full-bridge circuit module. The corresponding proportion is a value between 0 and 1 that is set by the user based on an application requirement.

For each buck/boost circuit module and full-bridge circuit module, the corresponding proportions may be the same or different. In an embodiment, a sum of all corresponding proportions of the buck/boost circuit modules and the full-bridge circuit modules is 1.

In an embodiment, the control method for a direct current conversion circuit further includes: obtaining the output current of the buck/boost circuit module based on the first duty cycle; and obtaining the output current of the full-bridge circuit module based on the second duty cycle.

In an embodiment, the control method for a direct current conversion circuit further includes: obtaining a bus current based on the output current of the at least one buck/boost circuit module and the output current of the at least one full-bridge circuit module; and obtaining an actual bus voltage based on the bus current.

In embodiments shown in FIG. 1, the foregoing control method for a direct current conversion circuit is used in a boost mode of the direct current conversion circuit, because the full-bridge circuit module cannot be completely disconnected in a buck mode, and a freewheeling diode in the full-bridge circuit module may still be connected. However, a person skilled in the art should understand that, when another full-bridge circuit (for example, a transistor does not include an anti-parallel diode) is used, the foregoing control method for a direct current conversion circuit may also be used in the buck mode of the direct current conversion circuit.

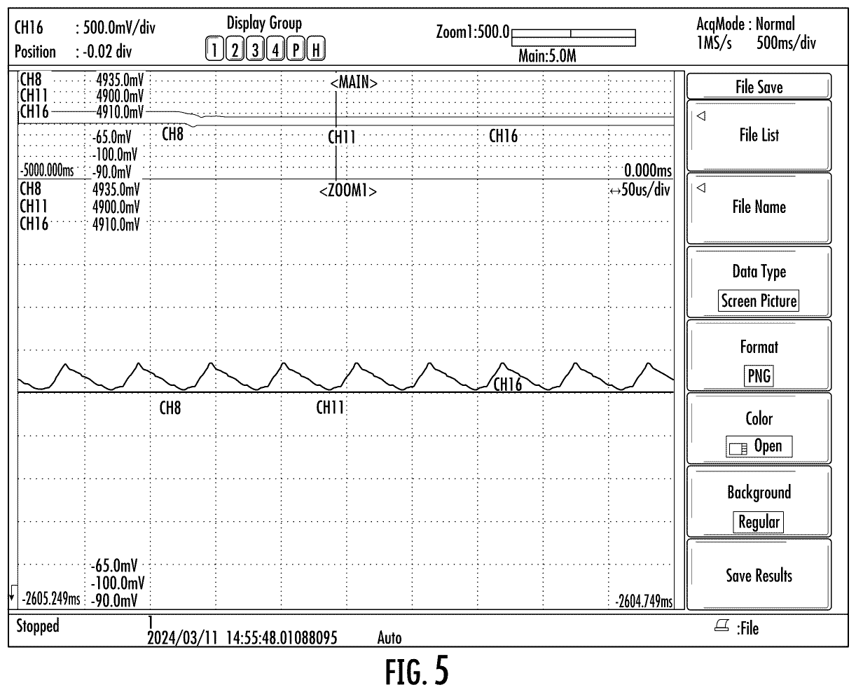

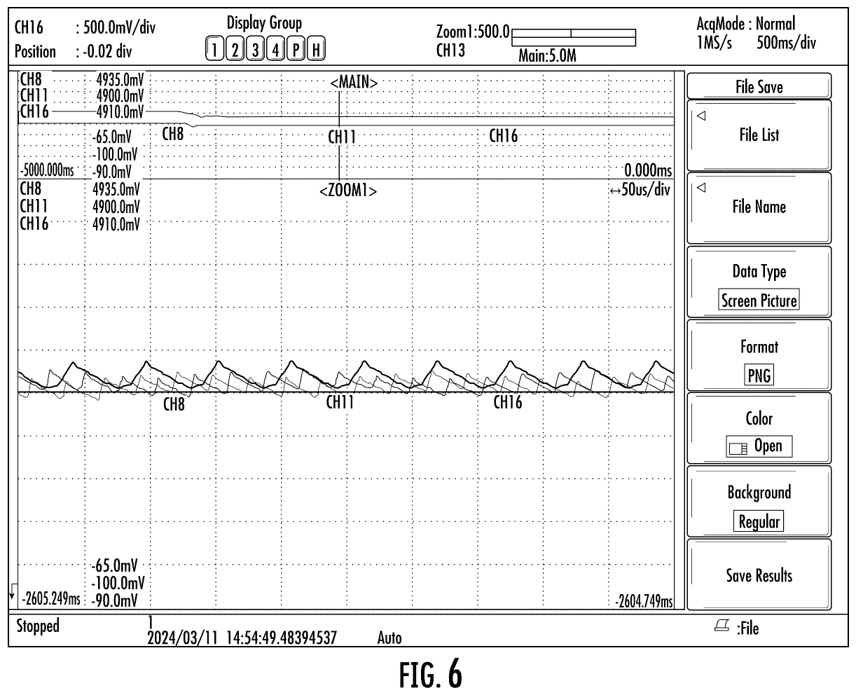

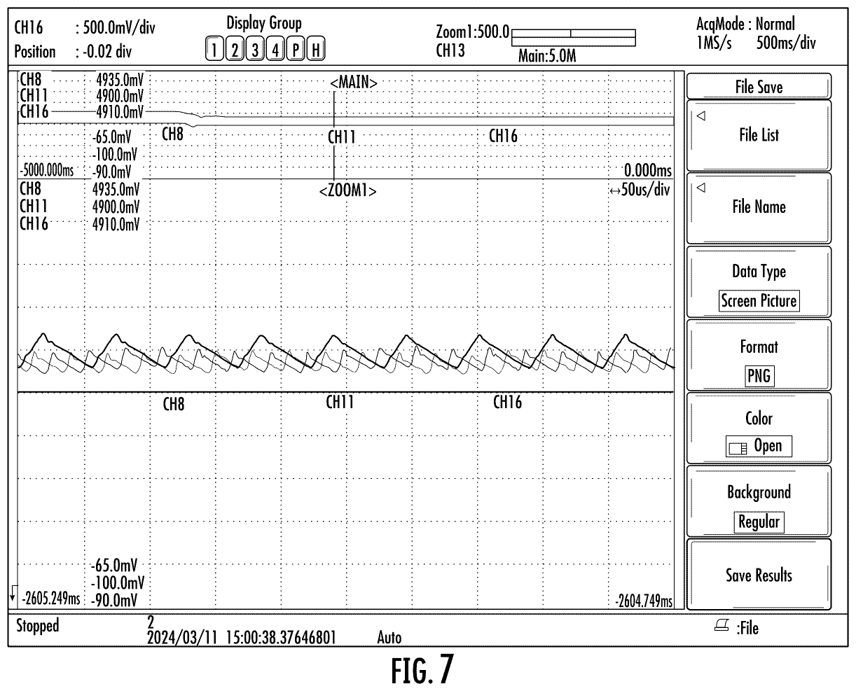

FIG. 5 shows a current waveform when a control method for a direct current conversion circuit according to the present inventive concept is used in a case of a small load, wherein CH8 and CH11 represent currents of a full-bridge circuit module, and CH16 represents a current of a buck/boost circuit module. It may be learned from the figure that, when an uninterruptible power supply has a relatively small load, only the buck/boost circuit module operates, and when the UPS has a relatively large load, the buck/boost circuit module and the full-bridge circuit module operate together (shown by the left side of a curve on the upper part in FIG. 5). FIG. 6 shows a current waveform when a control method for a direct current conversion circuit according to the present inventive concept is not used in a case of a small load, wherein CH8 and CH11 represent currents of a full-bridge circuit module, and CH16 represents a current of a buck/boost circuit module. As shown in FIG. 6, if the control method of the present inventive concept is not used, when the load is relatively small, a current changes from positive to negative in one PWM period, which is harmful to an energy storage apparatus. FIG. 7 shows a current waveform in a case of a high load, wherein CH8 and CH11 represent currents of a full-bridge circuit module, and CH16 represents a current of a buck/boost circuit module. When the load is relatively large, a current reference value is generally greater than a threshold, the buck/boost circuit module and the full-bridge circuit module operate together to support the load. In this case, the current is far greater than zero, so that the current flows only from an energy storage apparatus to a direct current bus.

Generally, in a steady state, a current reference value of a large load is relatively large, and a current reference value of a small load is relatively small. Even if the current reference value of a large load is less than a threshold, there is only a transient state case. Because a subsequent current ring has a high bandwidth, a current on an inductor completely tracks the current reference value. As long as the current reference value is less than the threshold, the current on the full-bridge circuit module may be negative. Therefore, as long as a reference current is less than the threshold, all full-bridge circuit modules are turned off, and the buck/boost circuit module operates normally.

According to the control method for a direct current conversion circuit in the present inventive concept, a current of a full-bridge circuit is prevented from changing to a negative value when a current reference value is less than a threshold, thereby protecting an energy storage apparatus and avoiding frequent charging and discharging of the energy storage apparatus.

Although the present inventive concept has been described by using some embodiments, the present inventive concept is not limited to the embodiments described herein, and includes various changes and variations without departing from the scope of the present inventive concept.

What is claimed is:

1. A control method for a direct current conversion circuit, wherein the direct current conversion circuit is connected between an energy storage apparatus and direct current buses, and comprises at least one buck/boost circuit module and at least one full-bridge circuit module that are connected in parallel; the control method comprises an external voltage control loop and an internal current control loop, wherein each of the at least one buck/boost circuit module and the at least one full-bridge circuit module corresponds to one internal current control loop; and the control method comprises:
obtaining a voltage error based on a predetermined bus reference voltage and an actual bus voltage;
obtaining a current reference value for the internal current control loop based on the voltage error; and
disconnecting the at least one full-bridge circuit module when the current reference value is less than a threshold.

2. The control method for a direct current conversion circuit of claim 1, further comprising:
continuously monitoring the current reference value, and when the current reference value is greater than the threshold, reconfiguring the at least one full-bridge circuit module to an operating mode.

3. The control method for a direct current conversion circuit of claim 2, further comprising:
when reconfiguring the at least one full-bridge circuit module to be in a boost mode, configuring a predetermined startup duty cycle for the at least one full-bridge circuit module, so that an output voltage of the at least one full-bridge circuit module is greater than or equal to the bus voltage and is less than a predetermined bus voltage maximum value in a first pulse width modulation period.

4. The control method for a direct current conversion circuit of claim 3, wherein the predetermined startup duty cycle is:
$$\frac{1}{2} - \frac{{V}_{BAT}}{2 {V}_{busmax}} > D \geq \frac{1}{2} - \frac{{V}_{BAT}}{2 {V}_{bus}}$$
wherein D is the predetermined startup duty cycle, V_{BAT} is an energy storage apparatus voltage, V_{bus} is the bus voltage, and V_{busmax} is the predetermined bus voltage maximum value.

5. The control method for a direct current conversion circuit of claim 1, wherein the internal current control loop comprises:
for each buck/boost circuit module, obtaining a first current error based on a current reference value of a corresponding proportion and an output current of the buck/boost circuit module; and
obtaining, through proportional-integral-derivative control based on the first current error, a first duty cycle used to control the buck/boost circuit module.

6. The control method for a direct current conversion circuit of claim 5, wherein the internal current control loop comprises:
for each full-bridge circuit module, obtaining a second current error based on a current reference value of a corresponding proportion and an output current of the full-bridge circuit module; and
obtaining, through proportional-integral-derivative control based on the second current error, a second duty cycle used to control the full-bridge circuit module.

7. The control method for a direct current conversion circuit of claim 6, further comprising:
obtaining the output current of the buck/boost circuit module based on the first duty cycle; and obtaining the output current of the full-bridge circuit module based on the second duty cycle.

8. The control method for a direct current conversion circuit of claim 7, further comprising:
obtaining a bus current based on the output current of the at least one buck/boost circuit module and the output current of the at least one full-bridge circuit module; and
obtaining an actual bus voltage based on the bus current.

9. The control method for a direct current conversion circuit of claim 1, wherein the current reference value is obtained through proportional-integral-derivative control based on the voltage error.

10. The control method of claim 1, wherein the direct current conversion circuit operates in a boost mode in which the energy storage apparatus supplies power to the direct current buses.
